(19) United States
(12) Patent Application Publication
(10) Pub. No.: US 2026/0290721 A1
(43) Pub. Date: Sep. 24, 2026

(54) BUTTON STRUCTURE

(71) Applicant: CHENG UEI PRECISION INDUSTRY CO., LTD., New Taipei City (TW)

(72) Inventors: YI HSU, New Taipei City (TW); TSUNG-SHIH LEE, New Taipei City (TW)

(21) Appl. No.: 19/278,736

(22) Filed: Jul. 23, 2025

(30) Foreign Application Priority Data
Feb. 5, 2025 (CN) 202520181777.6

(51) Int. Cl. H01H 13/52; H01H 13/04

(52) U.S. Cl. CPC H01H 13/52; H01H 13/04

(57) ABSTRACT

A button structure includes a key cap, a bracket surrounding the key cap, an elastic metal element and a circuit board. The elastic metal element is disposed in the key cap. The elastic metal element has a connecting portion. Two opposite ends of the connecting portion extend sideward and outward to form two elastic arms. The two elastic arms are partially disposed in the key cap. Top ends of the two elastic arms abut against a top surface of an inside of the key cap. The connecting portion and bottom ends of the two elastic arms are exposed to a bottom of the key cap. The circuit board is mounted under a bottom surface of the elastic metal element. A top surface of the circuit board is equipped with two conductive pads. Each conductive pad contacts with the bottom ends of the two elastic arms.

### CROSS REFERENCE TO RELATED APPLICATIONS

The present application is based on, and claims priority from, China Patent Application No. 202520181777.6, filed Feb. 5, 2025, the disclosure of which is hereby incorporated by reference herein in its entirety.

### BACKGROUND OF THE INVENTION

### Field of the Invention

The present invention generally relates to a button structure, and more particularly to a button structure which is capable of simplifying an assembling process and having a better assembling stability.

### Description of Related Art

A function button is a standard component in a game controller. The function button abuts against a switch of a circuit board. When the function button is pressed downward, the function button triggers the switch. The game controller executes a corresponding action. When the function button is released, the function button is returned to an initial position by an elastic force of an elastic element.

A conventional button structure includes a compression spring, a key cap, a switch, a circuit board and a shell. A mechanical arm includes the conventional button structure. The switch is disposed to a top surface of the circuit board. The circuit board is disposed in the shell. The compression spring is mounted around the switch. The key cap is disposed in a keyhole of the shell. The key cap moves with respect to the keyhole to compress the compression spring and trigger the switch. The compression spring is a polygonal spring.

However, the compression spring of the conventional button structure is used as a conductor. The compression spring of the conventional button structure is soldered to the circuit board. The compression spring and the switch of the conventional button structure are linearly arranged inside the key cap. Furthermore, an internal space of the key cap of the conventional button structure is smaller, and correspondingly a difficult assembly of the conventional button structure is caused. In addition, the key cap needs being flipped for soldering the compression spring, so assembling procedures of the conventional button structure are increased.

Thus, it is essential to provide an innovative button structure which is capable of simplifying an assembling process and having a better assembling stability.

### BRIEF SUMMARY OF THE INVENTION

An object of the present invention is to provide a button structure capable of simplifying an assembling process and having a better assembling stability. The button structure includes a key cap, a bracket surrounding the key cap, an elastic metal element and a circuit board. The elastic metal element is disposed in the key cap. The elastic metal element has a connecting portion and two elastic arms. Two opposite ends of the connecting portion extend sideward and outward to form the two elastic arms. The two elastic arms are partially disposed in the key cap. Top ends of the two elastic arms abut against a top surface of an inside of the key cap. The connecting portion and bottom ends of the two elastic arms are exposed to a bottom of the key cap. The connecting portion and the bottom ends of the two elastic arms extend beyond a bottom surface of the key cap. The circuit board is mounted under a bottom surface of the elastic metal element. A top surface of the circuit board is equipped with two conductive pads. Each conductive pad is corresponding to the bottom ends of the two elastic arms. Each conductive pad contacts with the bottom ends of the two elastic arms. Each conductive pad is electrically connected with the bottom ends of the two elastic arms.

Another object of the present invention is to provide a button structure. The button structure includes a key cap, a bracket surrounding the key cap, an elastic metal element and a circuit board. The elastic metal element is disposed in the key cap. The elastic metal element has a connecting portion. Each end of the elastic metal element has two opposite contacting portions, two extending portions and a fastening portion. Two opposite ends of the connecting portion extend sideward to form the two contacting portions. A top end of each contacting portion slantwise extends upward and inward, then is bent upward and outward, and then slantwise extends upward and outward to form one extending portion. Two top ends of the two extending portions of each end of the elastic metal element extend towards each other to form the fastening portion. The two extending portions of each end of the elastic metal element are symmetrically disposed to two opposite sides of the fastening portion. The two contacting portions of each end of the elastic metal element are symmetrically disposed to the two opposite sides of the fastening portion. The two fastening portions of the elastic metal element abut against a top surface of an inside of the key cap. The circuit board is mounted under a bottom surface of the elastic metal element. A top surface of the circuit board is equipped with two conductive pads. The two conductive pads are corresponding to the contacting portions of the elastic metal element. The contacting portions of the elastic metal element contact with the two conductive pads. The contacting portions of the elastic metal element are electrically connected with the two conductive pads.

Another object of the present invention is to provide a button structure. The button structure includes a key cap, an elastic metal clip and a circuit board. The elastic metal clip has a connecting portion and two elastic arms. Two opposite ends of the connecting portion extend sideward to form the two elastic arms. The two elastic arms are symmetrically disposed opposite to each other. Bottoms of the elastic arms have contacting portions. The circuit board is mounted under the contacting portions of the elastic metal clip. The circuit board has a switch and two conductive pads. The key cap is corresponding to the switch. The contacting portions of the two elastic arms abut against the two conductive pads. Wherein, before the elastic metal clip is assembled in the key cap, the two elastic arms of the elastic metal clip expand outward, the two elastic arms of the elastic metal clip are pressed inward and towards each other, and then the two elastic arms of the elastic metal clip are assembled in the key cap wherein, after the elastic metal clip is assembled in the key cap, the two elastic arms of the elastic metal clip expand outward to abut against an inner surface of key cap by elastic force of the two elastic arms the elastic metal clip.

As described above, the two conductive pads of the circuit board are corresponding to the contacting portions of the two elastic arms. The fastening portion abuts against the top surface of the inside of the key cap. The two extending portions are symmetrically disposed to the two opposite sides of the fastening portion, and the two contacting portions are symmetrically disposed to the two opposite sides of the fastening portion. When the key cap is pressed downward, the key cap drives the elastic metal element to press downward. The two extending portions of each elastic arm expand towards two opposite sides of the key cap, respectively. The contacting portions of the elastic metal element contact with the two conductive pads of the circuit board, and the contacting portions of the elastic metal element are electrically connected with the two conductive pads of the circuit board. As a result, the button structure is capable of simplifying the assembling process and having the better assembling stability.

### BRIEF DESCRIPTION OF THE DRAWINGS

The present invention will be apparent to those skilled in the art by reading the following description, with reference to the attached drawings, in which:

FIG. 1 is a perspective view of a button structure in accordance with a preferred embodiment of the present invention;

FIG. 2 is an exploded view of the button structure of FIG. 1;

FIG. 3 is a diagrammatic drawing of the button structure of FIG. 1;

FIG. 4 is a sectional diagram of the button structure along a line IV-IV of FIG. 3;

FIG. 5 is a perspective view of a key cap of the button structure of FIG. 1; and

FIG. 6 is a perspective view of an elastic metal element of the button structure according to the present invention.

### DETAILED DESCRIPTION OF THE INVENTION

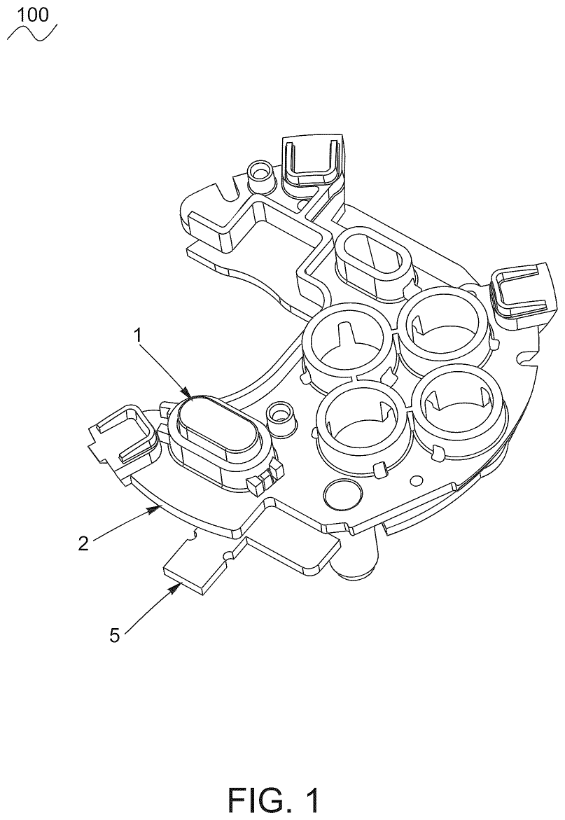

With reference to FIG. 1 to FIG. 4, a button structure 100 according to a preferred embodiment of the present invention is shown. The button structure 100 includes a key cap 1, a bracket 2, an elastic metal element 3, a switch 4 and a circuit board 5.

The bracket 2 surrounds the key cap 1. The elastic metal element 3 is disposed in the key cap 1. The key cap 1, the bracket 2, the elastic metal element 3 and the switch 4 are disposed to a top surface of the circuit board 5. A top end of the elastic metal element 3 abuts against a top surface of an inside of the key cap 1. A bottom end of the elastic metal element 3 contacts with the circuit board 5. The bottom end of the elastic metal element 3 is electrically connected with the circuit board 5. The bottom end of the elastic metal element 3 and the circuit board 5 are electrically conductive.

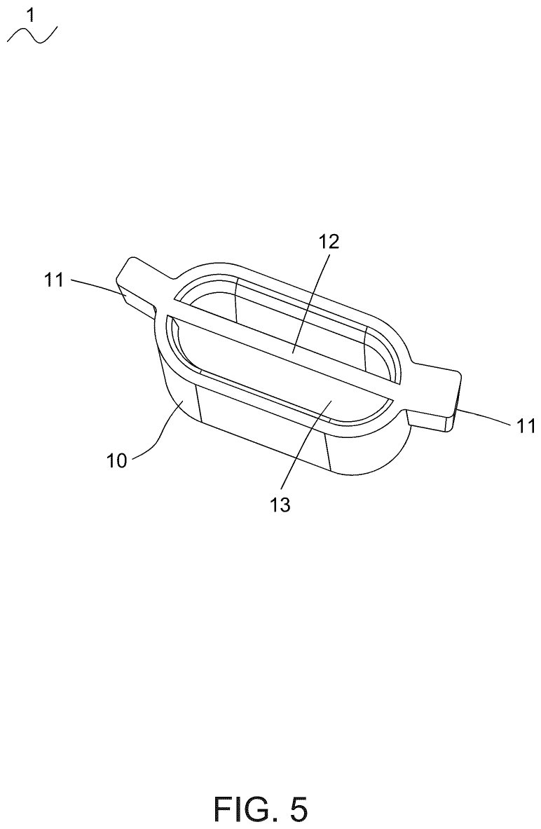

Referring to FIG. 1 and FIG. 5, the key cap 1 has a main portion 10, a plurality of assembling portions 11 and a pressing portion 12. Two opposite sides of an outer surface of the key cap 1 extend outward to form the plurality of the assembling portions 11. In the preferred embodiment, two opposite sides of an outer surface of the main portion 10 extend outward to form the plurality of the assembling portions 11. In a concrete implementation, the plurality of the assembling portions 11 are without being formed at the two opposite sides of the outer surface of the main portion 10. The plurality of the assembling portions 11 are disposed in corresponding mechanisms of the bracket 2 to realize that the key cap 1 is located in the bracket 2, and that the key cap 1 is fastened in the bracket 2. Specifically, the two opposite sides of the outer surface of the main portion 10 extend outward to form two assembling portions 11.

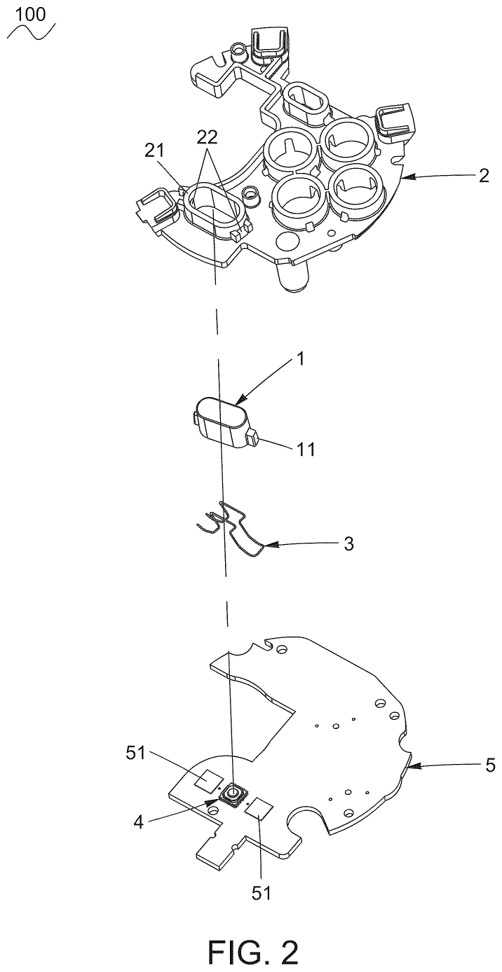

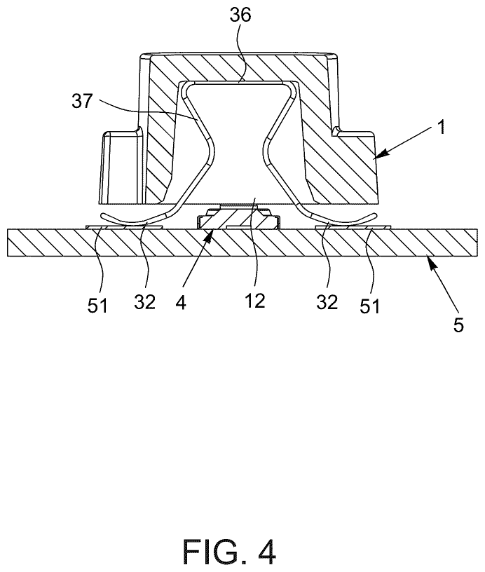

Referring to FIG. 1, FIG. 2, FIG. 4 and FIG. 5, a middle of an upper inner surface of the main portion 10 of the key cap 1 extends downward to form the pressing portion 12. The pressing portion 12 is corresponding to the switch 4. The pressing portion 12 is used for pressing the switch 4. In one situation, an inside of the main portion 10 of the key cap 1 is separated into two receiving slots 13 by the pressing portion 12. A part of the elastic metal element 3 is disposed in the two receiving slots 13.

In another situation, an inside the main portion 10 of the key cap 1 defines a receiving slot 13. The pressing portion 12 is disposed in a middle of the receiving slot 13. The pressing portion 12 and the main portion 10 are integrally formed by an integral injection molding technology, so the main portion 10 has the single receiving slot 13. The pressing portion 12 is disposed in a middle of the receiving slot 13. The pressing portion 12 extends transversely. The elastic metal element 3 is disposed in the receiving slot 13. The elastic metal element 3 is disposed to two opposite ends of the pressing portion 12.

Referring to FIG. 2, the bracket 2 has a hollow surrounding portion 21 and a plurality of assembling holes 22. In the preferred embodiment, the bracket 2 has two assembling holes 22. A top surface of the bracket 2 extends upward to form the hollow surrounding portion 21. The hollow surrounding portion 21 penetrates through the top surface and a bottom surface of the bracket 2. The main portion 10 of the key cap 1 is disposed in the surrounding portion 21. A top of the main portion 10 is exposed out of the surrounding portion 21.

The bottom surface of the bracket 2 is recessed upward to form the plurality of the assembling holes 22 penetrating through the top surface of the bracket 2. The plurality of the assembling holes 22 are communicated with an inside of the surrounding portion 21. In the preferred embodiment, the plurality of the assembling holes 22 are formed at two opposite sides of the surrounding portion 21. In a concrete implementation, the plurality of the assembling holes 22 are without being formed at the two opposite sides of the surrounding portion 21. In the concrete implementation, the plurality of the assembling holes 22 penetrate through the top surface and the bottom surface of the bracket 2. The plurality of the assembling portions 11 of the key cap 1 are disposed in the plurality of the assembling holes 22 to realize that the bracket 2 is located in the key cap 1, and that the bracket 2 is fastened in the key cap 1.

Two sides of the bottom surface of the bracket 2 are recessed upward to form the two assembling holes 22 penetrating through the top surface of the bracket 2. The two assembling holes 22 are communicated with the inside of the surrounding portion 21. The two assembling holes 22 are formed at the two opposite sides of the surrounding portion 21. The two assembling holes 22 penetrate through the top surface and the bottom surface of the bracket 2. The two assembling portions 11 of the key cap 1 are disposed in the two assembling holes 22.

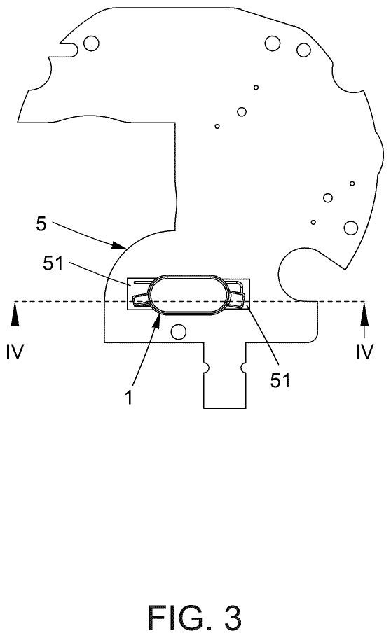

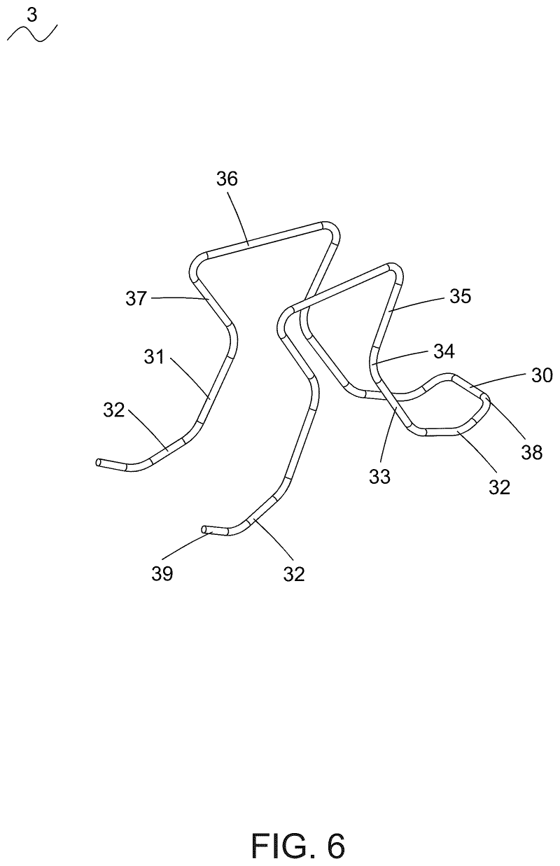

Referring to FIG. 3, FIG. 4 and FIG. 6, the elastic metal element 3 is a metal clip. The elastic metal element 3 has a connecting portion 30 and two elastic arms 31. Two opposite ends of the connecting portion 30 extend sideward and outward to form the two elastic arms 31. The two elastic arms 31 of the elastic metal element 3 are disposed to the two opposite ends of the pressing portion 12. The two elastic arms 31 are symmetrical and are opposite to each other. The two elastic arms 31 are partially disposed in the two receiving slots 13 of the key cap 1. Top ends of the two elastic arms 31 abut against a top surface of the inside of the key cap 1.

The circuit board 5 is mounted under a bottom surface of the elastic metal element 3. Bottom ends of the two elastic arms 31 contact with the circuit board 5. The bottom ends of the two elastic arms 31 are electrically connected with the circuit board 5. The bottom ends of the two elastic arms 31 and the circuit board 5 are conductive. The connecting portion 30 and the bottom ends of the two elastic arms 31 are exposed out of the two receiving slots 13 of the key cap 1. The connecting portion 30 and the bottom ends of the two elastic arms 31 extend beyond the outer surface of the main portion 10 of the key cap 1. The connecting portion 30 and the bottom ends of the two elastic arms 31 are exposed to a bottom of the key cap 1. The connecting portion 30 and the bottom ends of the two elastic arms 31 extend beyond a bottom surface of the key cap 1.

Each end of the elastic metal element 3 has two opposite contacting portions 32, two extending portions 37 and a fastening portion 36. The two opposite ends of the connecting portion 30 extend sideward to form the two contacting portions 32. Each elastic arm 31 has the two V-shaped contacting portions 32, two lower arm portions 33, two bending portions 34, two upper arm portions 35 and the fastening portion 36. Each extending portion 37 of each elastic arm 31 has a lower arm portion 33, a bending portion 34 and an upper arm portion 35. Two opposite sides of each elastic arm 31 define the two V-shaped contacting portions 32. One outer side of one contacting portion 32 is connected with one end of the connecting portion 30. Middles of the two contacting portions 32 are arched downward. Two mouths of the two contacting portions 32 face upward. The two contacting portions 32 contact with corresponding mechanisms of the circuit board 5. The two contacting portions 32 are electrically connected with the corresponding mechanisms of the circuit board 5. The two contacting portions 32 and the corresponding mechanisms of the circuit board 5 are conductive.

Two top ends of the two contacting portions 32 slantwise extend upward and towards each other to form the two lower arm portions 33. The two lower arm portions 33 gradually approach each other along an upward direction. Two top ends of the two lower arm portions 33 are oppositely bent upward to form the two bending portions 34. Two top ends of the two bending portions 34 slantwise extend upward and outward to form the two upper arm portions 35. The two upper arm portions 35 gradually approach each other along a downward direction. An extending direction of each lower arm portion 33 is opposite to an extending direction of each upper arm portion 35. Two top ends of the two upper arm portions 35 extend towards each other to form the fastening portion 36. The fastening portion 36 abuts against the top surface of the inside of the key cap 1.

In the preferred embodiment, the two contacting portions 32 of each elastic arm 31 are symmetrically located to two opposite sides of the fastening portion 36. The two contacting portions 32 of one end of the each of the two elastic arms 31 are extended sideward from the two opposite ends of the connecting portion 30. The two lower arm portions 33 are symmetrically disposed to the two opposite sides of the fastening portion 36. The two bending portions 34 are symmetrically disposed to the two opposite sides of the fastening portion 36. The two upper arm portions 35 are symmetrically disposed to the two opposite sides of the fastening portion 36.

In the preferred embodiment, the lower arm portion 33, the bending portion 34 and the upper arm portion 35 of each extending portion 37 of each side of each elastic arm 31 form a C shape structure. In the concrete implementation, the lower arm portion 33, the bending portion 34 and the upper arm portion 35 of each side of each elastic arm 31 are without being limited to be the C shape structure. The two lower arm portions 33, the two bending portions 34, the two upper arm portions 35 and the fastening portion 36 of each end of the elastic metal element 3 are fastened in the one receiving slot 13. The two lower arm portions 33, the two bending portions 34, the two upper arm portions 35 and the fastening portion 36 of each elastic arm 31 are fastened in the one receiving slot 13. The contacting portions 32 of the two elastic arms 31 and the connecting portion 30 of the elastic metal element 3 are exposed out of the two receiving slots 13.

In the preferred embodiment, the lower arm portion 33, the bending portion 34 and the upper arm portion 35 of each side of each elastic arm 31 form one extending portion 37. The top end of each contacting portion 32 slantwise extends upward and inward, then is bent upward and outward, and then slantwise extends upward and outward to form the one extending portion 37. Two top ends of the two extending portions 37 of each end of the elastic metal element 3 extend towards each other to form the fastening portion 36. The two extending portions 37 of each end of the elastic metal element 3 are symmetrically disposed to the two opposite sides of the fastening portion 36. The two contacting portions 32 of each end of the elastic metal element 3 are symmetrically disposed to the two opposite sides of the fastening portion 36. Two top ends of the two extending portions 37 of the two opposite sides of each elastic arm 31 extend towards each other to form the fastening portion 36. The two extending portions 37 of each elastic arm 31 are symmetrically disposed to the two opposite sides of the fastening portion 36 of the elastic arm 31. The two contacting portions 32 of each elastic arm 31 are symmetrically disposed to the two opposite sides of the fastening portion 36 of the elastic arm 31.

In other words, the two opposite sides of the fastening portion 36 slantwise extends downward and inward to form the two upper arm portions 35. Bottom ends of the two upper arm portions 35 are bent downward and outward to form the two bending portions 34. Bottom ends of the two bending portions 34 slantwise extend downward and outward to form the two lower arm portions 33. Bottom ends of the two lower arm portions 33 slantwise extend downward and outward, and then slantwise extend upward and outward to form the two contacting portions 32. The two elastic arms 31 face each other along a longitudinal direction. The two elastic arms 31 are aligned along the longitudinal direction. Outer ends of the two contacting portions 32 of the one end of the each of the two elastic arms 31 extend towards each other to form the connecting portion 30 along the longitudinal direction. The outer ends of the two contacting portions 32 of the one end of the each of the two elastic arms 31 are connected by the connecting portion 30.

The two opposite sides of the fastening portion 36 extend downward and are curved inward to form the two extending portions 37, respectively. A bottom end of each extending portion 37 extends outward and is bent downward to define the contacting portion 32. The connecting portion 30 is connected with two tail sides of the two opposite contacting portions 32 of the two elastic arms 31. The fastening portion 36 and the two extending portions 37 are fastened in the receiving slot 13. The connecting portion 30 and the contacting portions 32 of the two elastic arms 31 are exposed out of the receiving slot 13. The connecting portion 30 and the contacting portions 32 of the two elastic arms 31 extend beyond the outer surface of the main portion 10 of the key cap 1.

Referring to FIG. 2 to FIG. 4, the top surface of the circuit board 5 is equipped with the switch 4 and two conductive pads 51. Each conductive pad 51 is corresponding to the bottom ends of the two elastic arms 31. Each conductive pad 51 contacts with the bottom ends of the two elastic arms 31. Each conductive pad 51 is electrically connected with the bottom ends of the two elastic arms 31. In the preferred embodiment, the two conductive pads 51 are disposed to two opposite sides of the switch 4, respectively. The two conductive pads 51 are corresponding to the contacting portions 32 of the two elastic arms 31 of the elastic metal element 3. The contacting portions 32 of the two elastic arms 31 abut against the two conductive pads 51. The contacting portions 32 of the elastic metal element 3 contact with the two conductive pads 51. The contacting portions 32 of the elastic metal element 3 are electrically connected with the two conductive pads 51.

The elastic metal element 3 has four contacting portions 32. The four contacting portions 32 of the elastic metal element 3 contact with the two conductive pads 51 of the circuit board 5. The four contacting portions 32 of the elastic metal element 3 are electrically connected with the two conductive pads 51 of the circuit board 5. The four contacting portions 32 of the elastic metal element 3 and the two conductive pads 51 of the circuit board 5 are conductive.

Referring to FIG. 1 to FIG. 6, when the key cap 1 is pressed downward, the pressing portion 12 of the key cap 1 presses downward on the switch 4. The two fastening portions 36 of the elastic metal element 3 abut against the top surface of the inside of the key cap 1. The key cap 1 drives the elastic metal element 3 to press downward. The bending portions 34 of the two elastic arms 31 shift towards two opposite sides of the key cap 1, respectively. The two lower arm portions 33 expand towards the two opposite sides of the key cap 1, respectively. The two extending portions 37 of each elastic arm 31 expand towards the two opposite sides of the key cap 1, respectively. A distance between the two lower arm portions 33 is increased. The four contacting portions 32 of the elastic metal element 3 expand towards the two opposite sides of the key cap 1, respectively. The four contacting portions 32 of the elastic metal element 3 contact with the two conductive pads 51 of the circuit board 5. The four contacting portions 32 of the elastic metal element 3 are electrically connected with the two conductive pads 51 of the circuit board 5. The four contacting portions 32 of the elastic metal element 3 and the two conductive pads 51 of the circuit board 5 are conductive.

A junction among the two contacting portions 32 of the one end of the each of the two elastic arms 31 and the connecting portion 30 is defined as a closed end 38. An area between the other two contacting portions 32 of the other ends of the two elastic arms 31 is defined as an opening end 39. The two contacting portions 32 of the opening end 39 are expanded outward. When the two elastic arms 31 are assembled within the key cap 1, the elastic metal element 3 continuously exerts a pressure force on the key cap 1. A distance between the two contacting portions 32 of the opening end 39 is decreased. The two contacting portions 32 of the opening end 39 generate a self-positioning effect in the key cap 1. The elastic metal element 3 is stably assembled in the key cap 1. An assembling process between the key cap 1 and the elastic metal element 3 is simplified, and a noise of the elastic metal element 3 inside the key cap 1 is reduced.

When the button structure 100 is assembled, the two elastic arms 31 of the elastic metal element 3 expand outward. Therefore, the two elastic arms 31 of the elastic metal element 3 are pressed inward and towards each other, and then the two elastic arms 31 of the elastic metal element 3 are assembled in the two receiving slots 13 of the key cap 1. In this way, the elastic metal element 3 stably abuts against inner wall surfaces of the two receiving slots 13 by an elastic force of the elastic metal element 3. Subsequently, the key cap 1 and the elastic metal element 3 are together assembled in the surrounding portion 21 of the bracket 2. At the same time, the assembling portions 11 of the key cap 1 are assembled in the assembling holes 22 of the bracket 2. Finally, the key cap 1, the bracket 2 and the elastic metal element 3 are assembled to the top surface of the circuit board 5.

As described above, the two conductive pads 51 of the circuit board 5 are corresponding to the contacting portions 32 of the two elastic arms 31. The fastening portion 36 abuts against the top surface of the inside of the key cap 1. The two extending portions 37 are symmetrically disposed to the two opposite sides of the fastening portion 36, and the two contacting portions 32 are symmetrically disposed to the two opposite sides of the fastening portion 36. When the key cap 1 is pressed downward, the key cap 1 drives the elastic metal element 3 to press downward. The two extending portions 37 of each elastic arm 31 expand towards the two opposite sides of the key cap 1, respectively. The four contacting portions 32 of the elastic metal element 3 contact with the two conductive pads 51 of the circuit board 5, and the four contacting portions 32 of the elastic metal element 3 are electrically connected with the two conductive pads 51 of the circuit board 5. As a result, the button structure 100 is capable of simplifying an assembling process and having a better assembling stability.

What is claimed is:

1. A button structure, comprising:
a key cap;
a bracket surrounding the key cap;
an elastic metal element disposed in the key cap, the elastic metal element having a connecting portion and two elastic arms, two opposite ends of the connecting portion extending sideward and outward to form the two elastic arms, the two elastic arms being partially disposed in the key cap, top ends of the two elastic arms abutting against a top surface of an inside of the key cap, the connecting portion and bottom ends of the two elastic arms being exposed to a bottom of the key cap, the connecting portion and the bottom ends of the two elastic arms extending beyond a bottom surface of the key cap; and
a circuit board mounted under a bottom surface of the elastic metal element, a top surface of the circuit board being equipped with two conductive pads, each conductive pad being corresponding to the bottom ends of the two elastic arms, each conductive pad contacting with the bottom ends of the two elastic arms, each conductive pad being electrically connected with the bottom ends of the two elastic arms.

2. The button structure as claimed in claim 1, wherein the key cap has a main portion, a middle of an upper inner surface of the main portion extends downward to form a pressing portion, an inside of the main portion is separated into two receiving slots by the pressing portion, a part of the elastic metal element is disposed in the two receiving slots, the connecting portion and the bottom ends of the two elastic arms are exposed out of two receiving slots, the top ends of the two elastic arms abut against the top surface of the inside of the key cap.

3. The button structure as claimed in claim 2, wherein each elastic arm has two contacting portions, two extending portions and a fastening portion, the two contacting portions of one ends of the two elastic arms are extended sideward from the two opposite ends of the connecting portion, a top end of each contacting portion slantwise extends upward and inward, then is bent upward and outward, and then slantwise extends upward and outward to form one extending portion, two top ends of the two extending portions of the two opposite sides of each elastic arm extend towards each other to form the fastening portion, the fastening portion abuts against the top surface of the inside of the key cap, the two extending portions of each elastic arm are symmetrical and are disposed to two opposite sides of the fastening portion, the two contacting portions of each elastic arm are symmetrically disposed to the two opposite sides of the fastening portion, the four contacting portions of the elastic metal element contact with the two conductive pads of the circuit board, the four contacting portions of the elastic metal element are electrically connected with the two conductive pads of the circuit board.

4. The button structure as claimed in claim 3, wherein each elastic arm has two lower arm portions, two bending portions and two upper arm portions, each extending portion has a lower arm portion, a bending portion and an upper arm portion, two top ends of the two contacting portions slantwise extend upward and towards each other to form the two lower arm portions, two top ends of the two lower arm portions are oppositely bent upward to form the two bending portions, two top ends of the two bending portions slantwise extend upward and outward to form the two upper arm portions, two top ends of the two upper arm portions extend towards each other to form the fastening portion, the two lower arm portions, the two bending portions, the two upper arm portions and the fastening portion of each elastic arm are fastened in one receiving slot, the contacting portions of the two elastic arms and the connecting portion are exposed out of the two receiving slots.

5. The button structure as claimed in claim 4, wherein the two lower arm portions gradually approach each other along an upward direction.

6. The button structure as claimed in claim 4, wherein the two upper arm portions gradually approach each other along a downward direction.

7. The button structure as claimed in claim 4, wherein the lower arm portion, the bending portion and the upper arm portion of each side of each elastic arm form a C shape structure.

8. The button structure as claimed in claim 2, wherein a top surface of the bracket extends upward to form a hollow surrounding portion, the hollow surrounding portion penetrates through the top surface and a bottom surface of the bracket, the key cap is disposed in the surrounding portion, the bottom surface of the bracket is recessed upward to form a plurality of assembling holes penetrating through the top surface of the bracket, the plurality of the assembling holes are communicated with an inside of the surrounding portion, two opposite sides of an outer surface of the main portion extend outward to form a plurality of assembling portions, the plurality of the assembling portions are disposed in the plurality of the assembling holes.

9. The button structure as claimed in claim 1, wherein the two elastic arms are symmetrical and are opposite to each other.

10. A button structure, comprising:
a key cap;
a bracket surrounding the key cap;
an elastic metal element disposed in the key cap, the elastic metal element having a connecting portion, each end of the elastic metal element having two opposite contacting portions, two extending portions and a fastening portion, two opposite ends of the connecting portion extending sideward to form the two contacting portions, a top end of each contacting portion slantwise extending upward and inward, then being bent upward and outward, and then slantwise extending upward and outward to form one extending portion, two top ends of the two extending portions of each end of the elastic metal element extending towards each other to form the fastening portion, the two extending portions of each end of the elastic metal element being symmetrically disposed to two opposite sides of the fastening portion, the two contacting portions of each end of the elastic metal element being symmetrically disposed to the two opposite sides of the fastening portion, the two fastening portions of the elastic metal element abutting against a top surface of an inside of the key cap; and
a circuit board mounted under a bottom surface of the elastic metal element, a top surface of the circuit board being equipped with two conductive pads, the two conductive pads being corresponding to the contacting portions of the elastic metal element, the contacting portions of the elastic metal element contacting with the two conductive pads, the contacting portions of the elastic metal element being electrically connected with the two conductive pads.

11. The button structure as claimed in claim 10, wherein each end of the elastic metal element has two lower arm portions, two bending portions and two upper arm portions, each extending portion has a lower arm portion, a bending portion and an upper arm portion, two top ends of the two contacting portions slantwise extend upward and towards each other to form the two lower arm portions, two top ends of the two lower arm portions are oppositely bent upward to form the two bending portions, two top ends of the two bending portions slantwise extend upward and outward to form the two upper arm portions, two top ends of the two upper arm portions extend towards each other to form the fastening portion, an extending direction of each lower arm portion is opposite to an extending direction of each upper arm portion.

12. The button structure as claimed in claim 11, wherein the key cap has a main portion, a middle of an upper inner surface of the main portion extends downward to form a pressing portion, an inside of the main portion is separated into two receiving slots by the pressing portion, the two lower arm portions, the two bending portions, the two upper arm portions and the fastening portion of each end of the elastic metal element are fastened in one receiving slot, the contacting portions and the connecting portion of the elastic metal element are exposed out of the two receiving slots.

13. The button structure as claimed in claim 11, wherein the lower arm portion, the bending portion and the upper arm portion of each extending portion form a C shape structure.

14. The button structure as claimed in claim 10, wherein a top surface of the bracket extends upward to form a hollow surrounding portion, the hollow surrounding portion penetrates through the top surface and a bottom surface of the bracket, the key cap is disposed in the surrounding portion, the bottom surface of the bracket is recessed upward to form a plurality of assembling holes penetrating through the top surface of the bracket, the plurality of the assembling holes are communicated with an inside of the surrounding portion, two opposite sides of an outer surface of the key cap extend outward to form a plurality of assembling portions, the plurality of the assembling portions are disposed in the plurality of the assembling holes.

15. A button structure, comprising:
a key cap;
an elastic metal clip, the elastic metal clip having a connecting portion and two elastic arms, two opposite ends of the connecting portion extending sideward to form the two elastic arms, the two elastic arms being symmetrically disposed opposite to each other, bottoms of the elastic arms having contacting portions; and
a circuit board mounted under the contacting portions of the elastic metal clip, the circuit board having a switch and two conductive pads, the key cap being corresponding to the switch, the contacting portions of the two elastic arms abutting against the two conductive pads;
wherein, before the elastic metal clip is assembled in the key cap, the two elastic arms of the elastic metal clip expand outward, the two elastic arms of the elastic metal clip are pressed inward and towards each other, and then the two elastic arms of the elastic metal clip are assembled in the key cap;
wherein, after the elastic metal clip is assembled in the key cap, the two elastic arms of the elastic metal clip expand outward to abut against an inner surface of key cap by elastic force of the two elastic arms the elastic metal clip.
